(19) United States
(12) Patent Application Publication
(10) Pub. No.: US 2018/0197391 A1
(43) Pub. Date: Jul. 12, 2018

(54) Security Tag

(71) Applicant: Danhui Luo, Lake Worth, FL (US)

(72) Inventor: Danhui Luo, Lake Worth, FL (US)

(21) Appl. No.: 15/842,950

(22) Filed: Dec. 15, 2017

Related U.S. Application Data
(60) Provisional application No. 62/443,655, filed on Jan. 7, 2017.
(60) Provisional application No. 62/443,656, filed on Jan. 7, 2017.

(51) Int. Cl. G08B 13/24

(52) U.S. Cl. CPC G08B 13/2434

(57) ABSTRACT

The security tag comprises a housing, EAS or RFID sensor, locking mechanism, a spring-biased clip, a pin connecting to the housing, and a spring-biased pin safety guard for injury prevention. The operating methods involve: inserting an article (e.g., clothing) between the safety guard and the clip, depressing the clip to attach the security tag to the article (e.g., clothing); placing the security tag on a detacher, the clip rises up automatically and the article (e.g., clothing) separates from the security tag automatically.

### CROSS-REFERENCE TO RELATED APPLICATIONS

This application claims the benefit of U.S. Provisional Patent Application No. 62/443,655 and 62/443,656 filed on Jan. 7, 2017, entire disclosure of which is incorporated by reference herein.

### FIELD OF THE INVENTION

The inventive arrangements relate to security tags that secure onto articles, and allow the presence of the articles to be detected by compatible Electronic Article Surveillance (EAS) systems or Radio Frequency Identification (RFID) systems.

### BACKGROUND OF THE INVENTION

It is a common practice for retail stores to protect articles with security tags containing EAS sensor, RFID sensor, or combination of both. As is known in the art, security tag can be constructed in any number of configurations. The desired configuration is often dictated by nature of the article to be protected. For soft goods (e.g., clothing), the security tag comprises a rigid housing in which a security sensor is disposed. The rigid housing typically includes a pin from a tack assembly which is inserted through a portion of goods (e.g., clothing) and secured in place via locking mechanism. Tack assembly is typically a separated body from security tag. Connection the tack assembly and security tag through a flexible lanyard is also popular to protect goods with loops (e.g., hand bags).

Two categories of security tag detachers are popular in the market. One category of detachers contains one or more magnets which provide the force to release magnetically actuated locking mechanism inside the security tag housing. The other category of detachers contains a rotational arcuate probe, which is guided by an arcuate channel inside the security tag housing to release the pin from locking mechanism. A grooved pin in tack assembly is required to work with the locking mechanism in this application.

Drawbacks of existing security tags including the safety threat of sharp pin and time consuming to operate. It is therefore desirable to provide a security tag which is safe, fast and easy to operate, particularly for retail stores with self-checkout option in which shoppers are expected to remove security tags by themselves.

### SUMMARY OF THE INVENTION

Disclosed herein is a security tag for application to articles such as clothing. The security tag includes a housing, a pin which is permanently connected to the housing, a spring-biased safety guard to protect the pin, and a spring-biased clip. The housing has an opening for insertion of the clip and a recess for retraction of the safety guard. The security tag intends to secure the article's edge.

When the security tag is at detached position, there is a space between the clip and the safety guard allowing article (e.g., clothing) insertion. By pressing the clip toward the housing, it travels to attached position and is locked by mechanism inside the housing. In the meanwhile, the safety guard is retracted by force from the clip so that the pin is emerged to penetrate article (e.g., clothing) and enter a receiving hole on the clip. The security tag is thus secured to the article (e.g., clothing). Once the security tag is presented to a detacher to release the locking mechanism, the clip automatically rises to the detached position by spring force, and the safety guard extends out by spring force to push the article (e.g., clothing) off the pin and hide the pin thereafter.

### DETAILED DESCRIPTION OF THE INVENTION

The security tag can be constructed in various configurations.

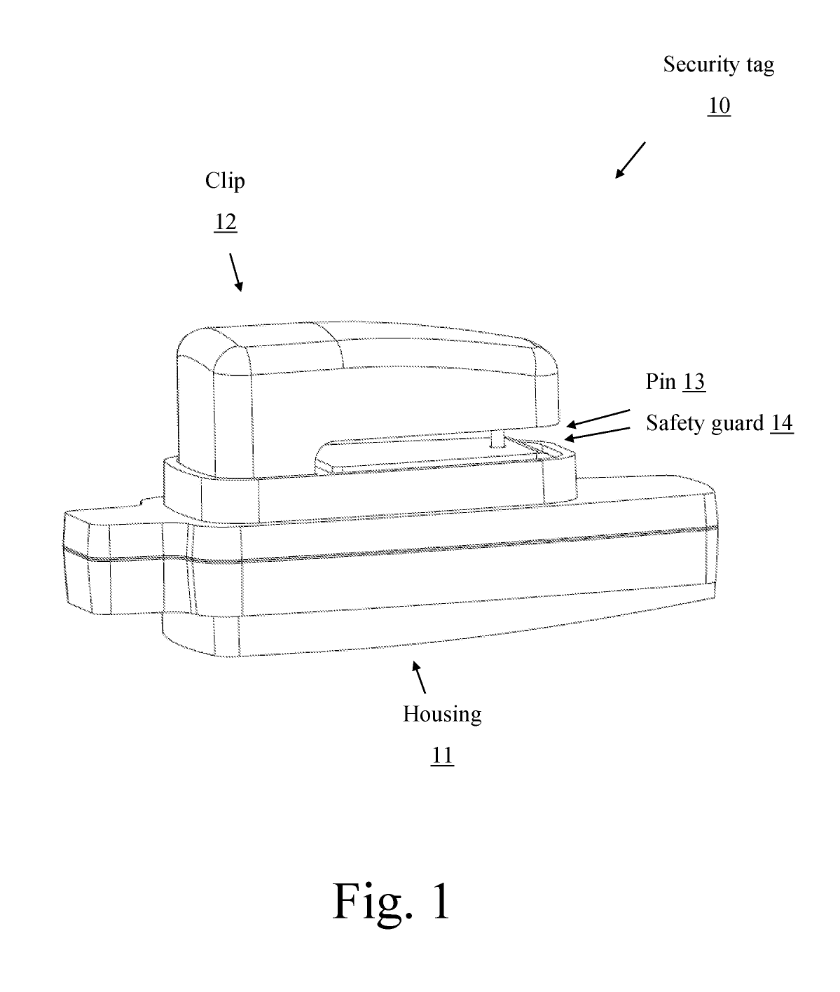

FIG. 1-5 describe an exemplary design of security tag for magnetic detacher with sensor permanently concealed in the housing.

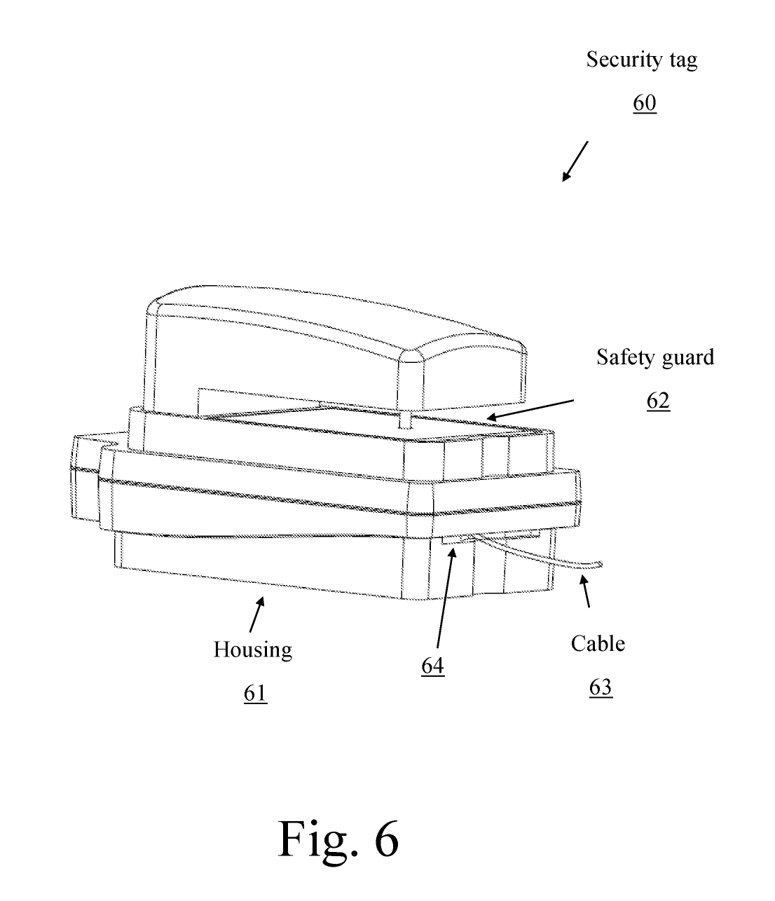

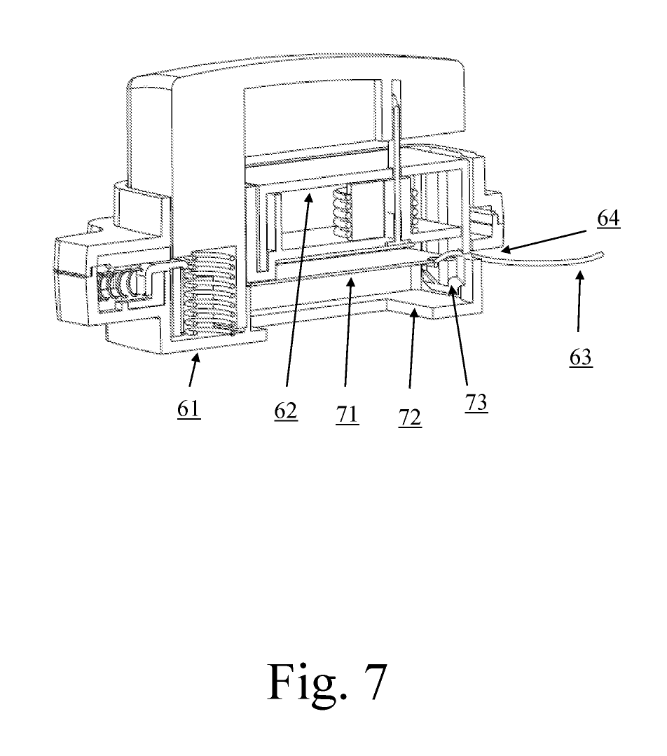

FIG. 6-7 shows another exemplary design of security tag for magnetic detacher with an insertable sensor.

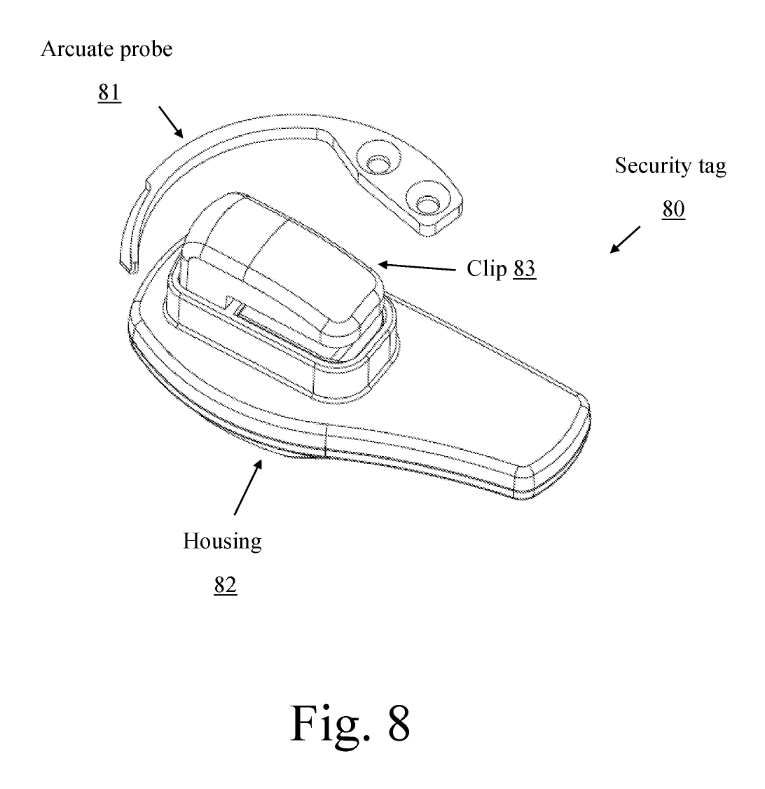

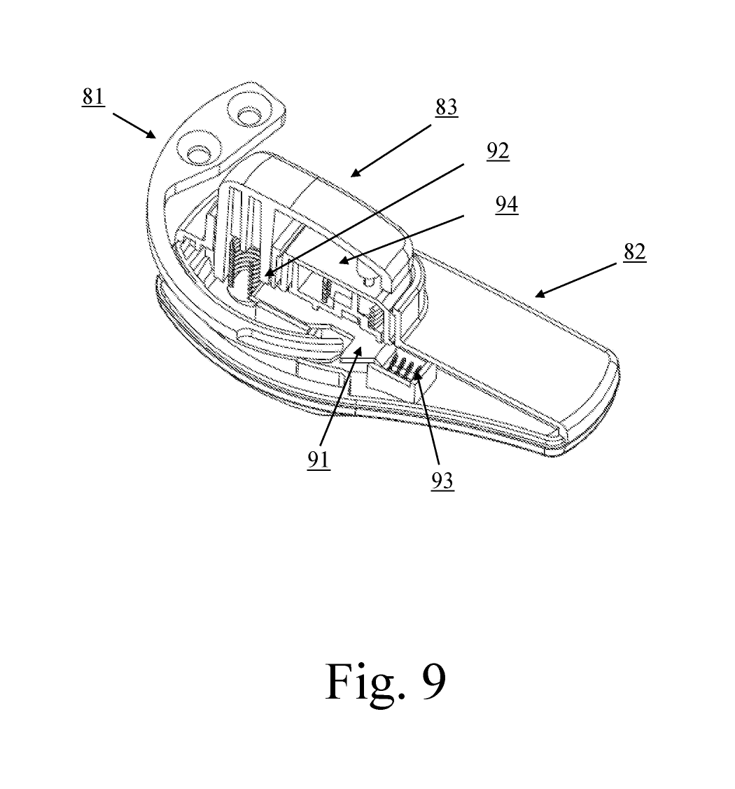

FIG. 8-9 illustrate still another exemplary design of security tag for detacher with an arcuate probe.

FIG. 1 illustrates an exemplary security tag design 10 at attached position. Clip 12 enters housing 11 through an opening and is locked down by mechanism inside housing 11. Pin 13 behind safety guard 14 is connected to housing 11 at one end, its other end with sharp tip enters a receiving hole on clip 12. When an article (e.g., clothing) is placed between safety guard 14 and clip 12, the sharp tip of pin 13 penetrates the article (e.g., clothing). Thus security tag 10 is attached to the article (e.g., clothing) and can't be removed without a detacher.

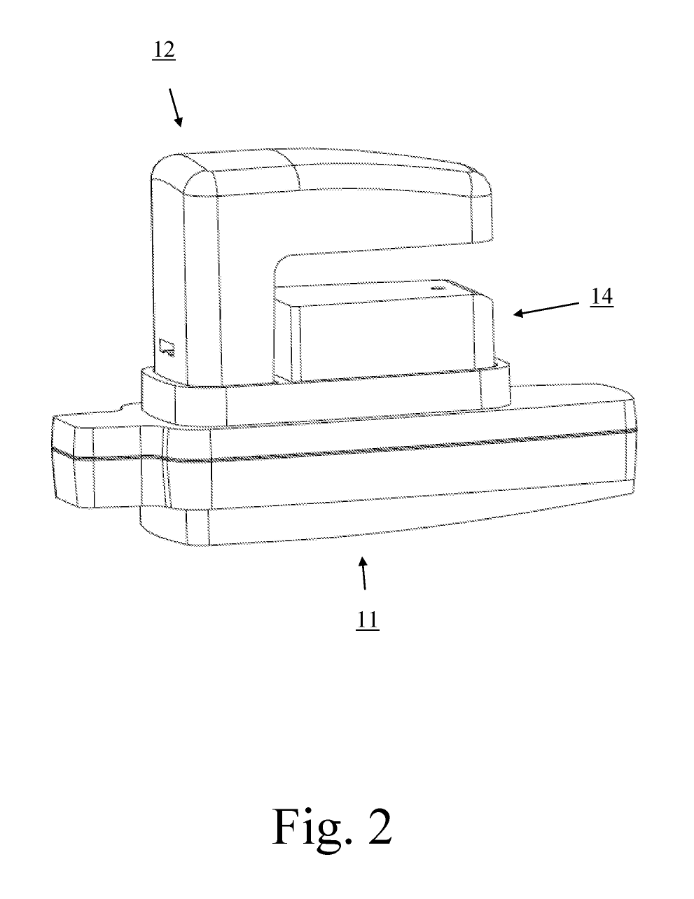

FIG. 2 depicts the exemplary security tag design 10 at detached position. Clip 12 rises up by internal spring force and is still inserted into the opening of housing 11. Safety guard 14 rises up by internal spring force to hide the sharp tip of pin 13 which eliminates the safety hazard. Gap between clip 12 and safety guard 14 allows article (e.g., clothing) to be inserted before attachment or to be removed after attachment.

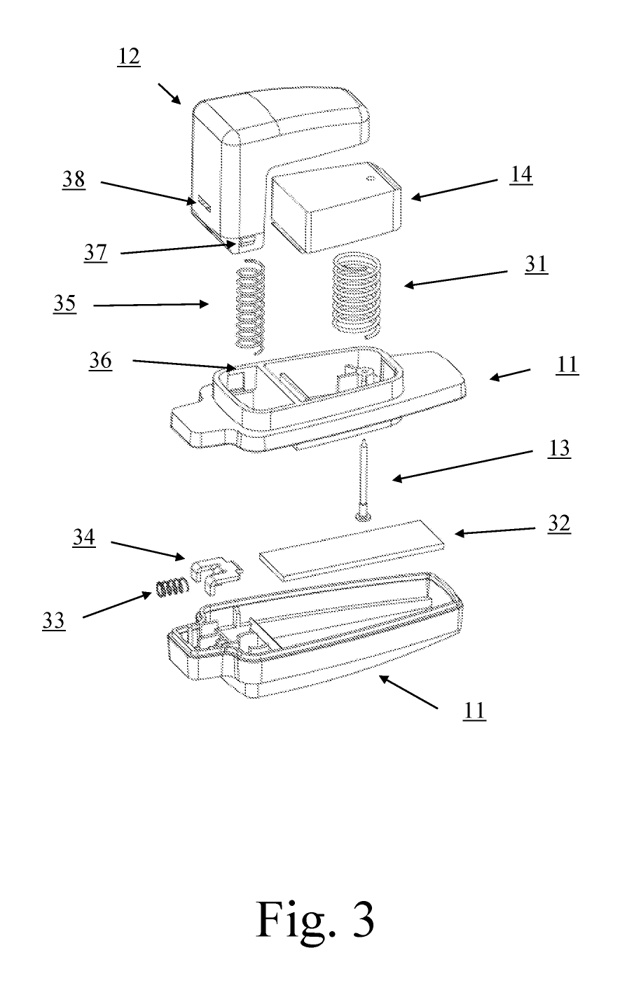

FIG. 3 exhibits an explosive view of all components of security tag 10. Housing 11 is typically consisted of two plastic parts which are ultrasonically welded together in assembling process. Latch 34 is to lock clip 12 into attached position under the force of spring 33. Sensor 32 represents an EAS label, or a RFID sensor, or combination of both.

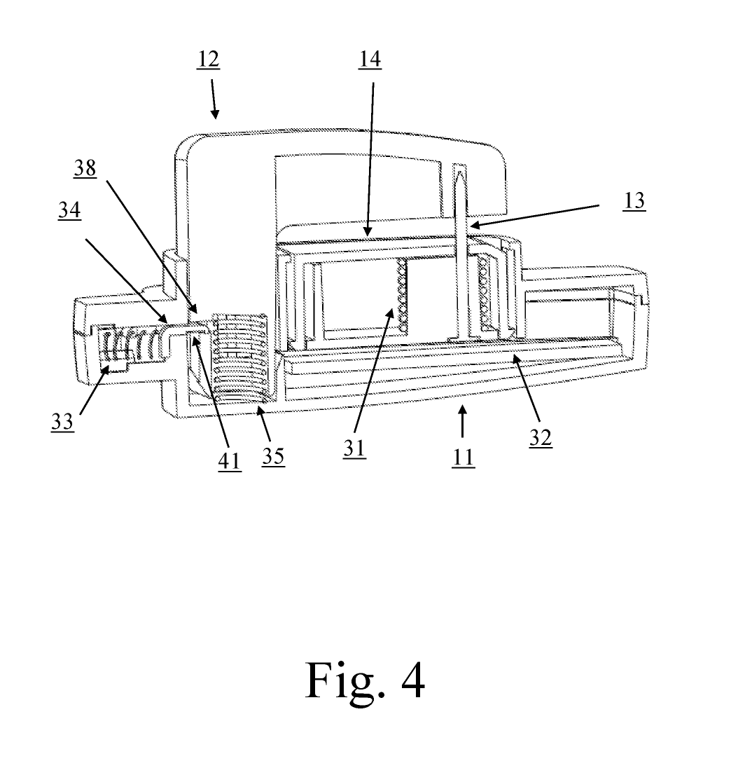

FIG. 4 is a dissection of security tag 10 in attached position without showing the article (e.g., clothing). Latch 34 is partially inserted into aperture 38 on clip 12 under the force from spring 33 so clip 12 is locked down. Besides pin 13 penetration to secure the article (e.g. clothing), safety guard 14 is being pushed by the force from spring 31 to clamp on the article (e.g., clothing). The clamping force reduces the chance to enlarge the pin hole on article (e.g., clothing) due to the weight of security tag 10 or forces from customer handling. Safety guard 14 is movable inside a recess on housing 11 to accommodate thickness variation of the article (e.g., clothing). Latch 34 is made of ferrous material. Only a magnetic detacher can release clip 12 from this locked position through applying magnetic force to latch 34. Recess 41 on latch 34 creates mechanical interlock with aperture 38 on clip 12, which prevents latch 34 be unlocked by external slam force during defeat attempt by thefts. The interlock can be removed by slightly pressing down clip 12 at normal detachment process.

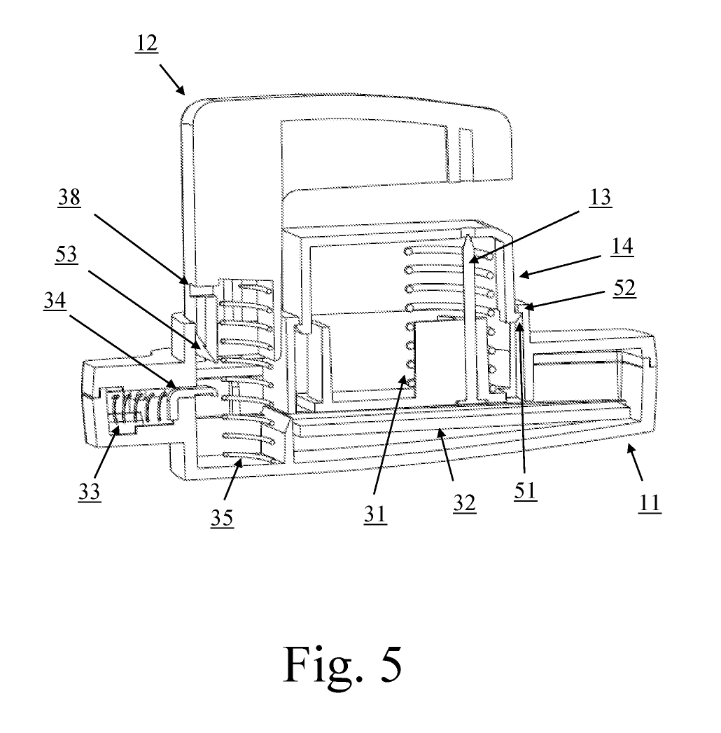

FIG. 5 is a dissection of security tag 10 in detached position. By presenting security tag 10 to a magnetic detacher and slightly pressing down clip 12, the magnetic force shall pull latch 34 in lateral direction guided by housing structures. Once latch 34 is separated from aperture 38 on clip 12, the force from spring 35 shall push clip 12 up, and the force from spring 31 shall push safety guard 14 up. Clip 12 is stopped when protrusions 37 on both sides of clip 12 meet the ledges 36 at both sides of the housing opening so clip 12 can't disengage from housing 11. Safety guard 14 is stopped when its protrusion 51 meets ledge 52 on housing 11 so they can't disengage. The movement of safety guard 14 also ensures a clean separation between pin 13 and the article (e.g., clothing). When security tag 10 is moved away from the magnetic detacher, latch 34 returns to original position under the force from spring 33.

Should security tag 10 be used again, an article (e.g., clothing) is inserted between safety guard 14 and clip 12, then clip 12 is pressed so that pin 13 penetrates the article (e.g., clothing). In the meantime, wedge surface 53 on clip 12 allows tip of latch 34 to ride on top and fall into aperture 38 on clip 12 under the force from spring 33 to lock clip 12 down in attached position. Security tag 10 can't be removed from the article (e.g., clothing) without a detacher.

FIG. 6 illustrates another exemplary security tag design 60 in attached position. The sensor inside housing 61 is attached to the article (e.g., clothing) through cable 63. Opening 64 on housing 61 allows the sensor to move through.

FIG. 7 is a dissection of security tag 60 in attached position. Opening 64 on housing 61 is blocked by structure 73 on safety guard 62 so sensor 71 can't be removed. Information (e.g., price) printed on surface of sensor 71 can be visible through opening 72 on housing 61. Opening 72 can be sealed by a transparent component for additional security.

When security tag 60 is being detached, safety guard 62 rises up to unblock opening 64 on housing 61 to allow sensor 71 exit. After security tag 60 is removed from the article (e.g., clothing), sensor 71 is still attached to the article (e.g., clothing) through cable 63 for merchandise return purpose.

FIG. 8 illustrates still another exemplary design of security tag 80 for detacher with an arcuate probe 81 in attached position.

FIG. 9 is a dissection of security tag 80 during detachment process. Arcuate probe 81 rotationally enters housing 82 through an arcuate channel and pushes latch 91 traveling away from aperture 92 on clip 83 guided by structures inside housing 82. Once latch 91 separates from clip 83, clip 83 and safety guard 94 rise up by spring forces to allow the article (e.g., clothing) removal. After arcuate probe 81 retracts from housing 82, latch 91 returns to the original position under the force from spring 93. Security tag 80 is ready to be used again.

I claim:

1. A security tag for attachment to articles such as clothing in an Electronic Article Surveillance (EAS) system or Radio Frequency Identification (RFID) system, comprising:
a housing with an exterior securing side containing an opening and a recess;
a pin with two ends, the first end connecting to the housing at base of the recess, the second end having a sharp tip protruding out from the housing securing side;
a safety guard for the pin insertable into the recess on the housing;
a locking mechanism disposed within the housing adjacent to the opening; and
a bifurcated clip with diverging first and second arms, the first arm being insertable into the opening on the housing and having a structure engagable with the locking mechanism, the second arm having an exterior securing side facing the securing side of the housing.

2. The security tag of claim 1, wherein the pin can be either smooth or grooved.

3. The security tag of claim 1, wherein the safety guard is spring biased and has structure to prevent it move completely out of the recess on the housing.

4. The security tag of claim 1. Wherein the safety guard has an opening allowing tip of the pin to pass through.

5. The security tag of claim 1, wherein the clip is spring biased and has structure to prevent its first arm move completely out of the opening on the housing.

6. The security tag of claim 1, wherein the structure on the first arm of the clip engagable with the locking mechanism includes, but not limited to, an aperture or recess.

7. The security tag of claim 1, wherein the securing side of the clip has a concave structure allowing the pin insertion.

8. The security tag of claim 3, wherein the spring applies force on safety guard to compress the article (e.g., clothing) when the clip is engaged to the locking mechanism.
